(19) United States
(12) Patent Application Publication
(10) Pub. No.: US 2025/0230347 A1
(43) Pub. Date: Jul. 17, 2025

(54) FLUOROBUTENE COMPOSITIONS COMPRISING E-1,1,1,4,4,4-HEXAFLUORO-2-BUTENE AND USES THEREOF

(71) Applicant: THE CHEMOURS COMPANY FC, LLC, Wilmington, DE (US)

(72) Inventors: SHENG PENG, HOCKESSIN, DE (US); BARBARA HAVILAND MINOR, THE VILLAGES, FL (US)

(73) Assignee: THE CHEMOURS COMPANY FC, LLC, Wilmington, DE (US)

(21) Appl. No.: 18/855,743

(22) PCT Filed: Apr. 21, 2023
(86) PCT No.: PCT/US2023/019330

§ 371 Date: Oct. 10, 2024

Related U.S. Application Data
(60) Provisional application No. 63/333,843, filed on Apr. 22, 2022.

(51) Int. Cl. C09K 5/04; C08J 9/14; C09K 3/30; C11D 7/50

(52) U.S. Cl. CPC C09K 5/044; C08J 9/144; C09K 3/30; C11D 7/5018; C08J 2203/182; C09K 2205/122; C09K 2205/126; C09K 2205/22

(57) ABSTRACT

The present disclosure relates to fluorobutene compositions comprising E-1, 1,1,4,4,4-hexafluoro-2-butene and fluorinated compounds that may be useful as refrigerants, heat transfer compositions, aerosol propellants, foaming agents, blowing agents, solvents, cleaning agents, carrier fluids, displacement drying agents, buffing abrasion agents, polymerization media, expansion agents for polyolefins and polyurethane, gaseous dielectrics, power cycle working fluids, extinguishing agents, and fire suppression agents in liquid or vapor form, and in methods for detecting leaks.

### FIELD OF THE INVENTION

The present invention relates broadly to fluorobutene compositions comprising E-1,1,1,4,4,4-hexafluor-2-butene (E-1336mzz) with improved performance, particularly in refrigeration applications.

### BACKGROUND OF THE INVENTION

New environmental regulations have led to the need for new compositions for use in a wide range of applications, including their use as aerosol propellants, refrigerants, cleaning agents, expansion agents for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents. Low ozone depletion and low global warming potential compounds are of particular interest. Certain hydrofluoroolefin compositions are believed to meet both goals.

E-HFO-1336mzz (E- or trans-1,1,1,4,4,4-hexafluoro-2-butene, trans-CF₃CH═CHCF₃) and Z—HFO-1336mzz (Z- or cis-1,1,1,4,4,4-hexafluoro-2-butene, cis-CF₃CH═CHCF₃), both having zero ozone depletion and low global warming potential, have been identified as potential refrigerants. WO 2007/53697 discloses compositions comprising E- and/or Z—HFO-1336mzz and their use in various applications.

### SUMMARY

E-1,1,1,4,4,4-hexafluoro-2-butene (E-HFO-1336mzz) can be used as a refrigerant, heat transfer fluid, foam expansion agent, power cycle working fluid, among other uses. It has also, advantageously, been found that E-HFO-1336mzz has a low global warming potential (GWP), GWP=32. Thus, fluorobutene compositions comprising E-HFO-1336mzz may be good candidates for replacing higher GWP saturated compounds such as CFCs (chlorofluorocarbons), HCFCs (hydrochlorofluorocarbons), or HFCs (hydrofluorocarbons) in many uses.

The present disclosure provides fluorobutene compositions comprising E-1,1,1,4,4,4-hexafluoro-2-butene (herein referred to as E-1336mzz or E1336mzz). More particularly, compositions comprise E-1336mzz and one or more fluorinated compound. The fluorinated compounds enhance properties of E-1336mzz in applications such as use as heat transfer fluids.

The present disclosure provides fluorobutene compositions comprising E-1,1,1,4,4,4-hexafluoro-2-butene and a fluorinated compound selected from the group consisting of 1,1,1,2,4,4,4-heptafluorobutane, 2-chloro-1,1,1-trifluoroethane, E-1-chloro-3,3,3-trifluoropropene, Z-1-chloro-3,3,3-trifluoropropene, and 2-chloro-3,3,3-trifluoropropene. The fluorobutene composition comprises at least 99% by weight of E-1,1,1,4,4,4-hexafluoro-2-butene.

The fluorobutene compositions may be as refrigerants, heat transfer compositions, thermodynamic cycle (e.g. heating or cooling cycle) working fluids, gaseous dielectrics, power cycle working fluids, as well as aerosol propellants, foaming agents (blowing agents), solvents, cleaning agents, carrier fluids, displacement drying agents, buffing abrasion agents, polymerization media, foaming agents for polyolefins and polyurethane, extinguishing agents, and fire suppression agents in liquid or gaseous form.

In some embodiments the fluorobutene composition comprises 0.0001 to 0.9 wt % of the fluorinated compound or 0.0005 to 0.4 wt % of the fluorinated compound or 0.005 to 0.2 wt % of the fluorinated compound.

In some embodiments, the fluorinated compound is 1,1,1,2,4,4,4-heptafluorobutane or 2-chloro-1,1,1-trifluoroethane, or E-1-chloro-3,3,3-trifluoropropene, or Z-1-chloro-3,3,3-trifluoropropene, or 2-chloro-3,3,3-trifluoropropene.

In some embodiments, the fluorobutene composition further comprises Z-1,1,1,4,4,4-hexafluoro-2-butene.

In some embodiments the fluorobutene compositions comprises E-1336mzz and E-1233zd or E-1336mzz, E-1233zd and Z-1336mzz.

In some embodiments, the fluorobutene composition has improved refrigeration performance over the performance of E-1336mzz alone. In certain embodiments, the improvement in performance is higher cooling capacity. In certain embodiments, the improvement in performance is greater efficiency (COP).

In some embodiments, the fluorobutene composition comprises a lubricant. In certain embodiments, such compositions show improved solubility of the lubricant with the E1336mzz and improved lubricity in heat transfer systems.

The fluorobutene compositions disclosed herein are non-flammable.

### DETAILED DESCRIPTION

### Compositions

E-HFO-1336mzz may be produced, for example, by reaction of chlorinated hydro(fluoro)carbons, such CF₃CHClCH₂CCl₃ (HCFC-343jfd) or CF₃CHClCH₂CF₃ (HCFC-346mdf) or CCl₃CHClCH₂CCl₃ (HCC-340jfd) or CCl₂═CClCH═CCl₂ (HCO-2320az) in liquid or gas phase; or by isomerization of Z—HFO-1336mzz. Processes to prepare E-HFO-1336mzz are disclosed, for example, in U.S. Pat. Nos. 9,174,896; 10,479,745; 10,611,709; US202110188743; WO 2020/206247; and WO 2020/206335. Such disclosures are incorporated herein by reference. Other processes to produce E-HFO-1336mzz are known by those skilled in the art.

In one embodiment, the present disclosure provides a fluorobutene composition comprising E-1,1,1,4,4,4-hexafluoro-2-butene and a fluorinated compound selected from the group consisting of 1,1,1,2,4,4,4-heptafluorobutane, 1,1,1,3,3-pentafluoropropane, 2-chloro-1,1,1-trifluoroethane, E-1-chloro-3,3,3-trifluoropropene, Z-1-chloro-3,3,3-trifluoropropene, and 2-chloro-3,3,3-trifluoropropene. The fluorobutene composition comprises at least 99% by weight of E-1,1,1,4,4,4-hexafluoro-2-butene.

E-HFO-1336mzz and the fluorinated compounds are available commercially or can be made by processes known in the art. Such compounds can be purchased from a specialty fluorochemical supplier, such as SynQuest Laboratories, Inc. (Alachua, Florida, USA).

E-HFO-1336mzz may be produced, for example, by reaction of chlorinated hydro(fluoro)carbons, such CF₃CHClCH₂CCl₃ (HCFC-343jfd) or CF₃CHClCH₂CF₃ (HCFC-346mdf) or CCl₃CHClCH₂CCl₃ (HCC-340jfd) or CCl₂═CClCH═CCl₂ (HCO-2320az) in liquid or gas phase; or by isomerization of Z—HFO-1336mzz. Processes to prepare E-HFO-1336mzz are disclosed, for example, in U.S. Pat. Nos. 9,174,896; 10,479,745; 10,611,709; US2021/0188743; WO 2020/206247; and WO 2020/206335. Such disclosures are incorporated herein by reference. Other processes to produce E-HFO-1336mzz are known by those skilled in the art.

The compositions of the present invention may comprise E-HFO-1336mzz and one fluorinated compound, or two fluorinated compounds, or three or more fluorinated compounds.

In one embodiment, the total amount of fluorinated compound(s) in the composition comprising E-HFO-1336mzz ranges from greater than zero weight percent to less than 1.0 weight percent, based on the total weight of the composition. In another embodiment, the total amount of fluorinated compound(s) ranges from greater than zero weight percent to less than 0.5 weight percent, based on the total weight of the composition. In another embodiment, the total amount of fluorinated compound(s) ranges from 0.01 ppm(weight) to about 1 weight percent. In another embodiment, the total amount of fluorinated compound(s) ranges from 0.1 ppm(weight) to about 1 weight percent. In another embodiment, the total amount of fluorinated compound(s) ranges from 0.001 weight percent to about 1 weight percent. In another embodiment, the total amount of fluorinated compound(s) ranges from 0.001 weight percent to about 0.5 weight percent.

Table 1 provides a list of the fluorinated compounds and other compounds which may be present in the fluorobutene compositions disclosed herein.

TABLE 1
Compound Names and Formulae

| Compound | Chemical formula | Chemical name |
|---|---|---|
| HC-30 | CH₂Cl₂ | dichloromethane (methylene chloride) |
| HCFC-114/114a | CF₂ClCF₂Cl/ | 1,2-dichloro-1,1,2,2-tetrafluoroethane/ |
| | CF₃CCFCl₂ | 2,2-dichloro-1,1,1,2-tetrafluoroethane |
| HCFC-133 | CHFCF₂Cl | 1-chloro-1,2,2-trifluoroethane |
| HCFC-133a | CF₃CH₂Cl | 2-chloro-1,1,1-trifluoroethane |
| HFC-245fa | CF₃CH₂CHF₂ | 1,1,1,3,3-pentafluoropropane |
| HFC-338 | C₄H₂F₈ | octafluorobutane |
| HFC-338mee | CF₃CHFCHFCF₃ | 1,1,1,2,3,4,4,4-octafluorobutane |
| HFC-338mf | CF₃CH2CF₂CF₃ | 1,1,1,2,2,4,4,4-octafluorobutane |
| HFC-347mef | CF₃CHFCH₂CF₃ | 1,1,1,2,4,4,4-heptafluorobutane |
| HCO-1140 | CH₂═CHCl | vinyl chloride (monomer) |
| HCFO-1224 isomers | C₃HF₄Cl | chloro-tetrafluoropropene |
| E-HCFO-1224yd | CF₃FC═CClH | (E)-1-chloro-2,3,3,3-tetrafluoroprop-1- |
| | | ene |
| Z-HCFO-1224yd | CF₃FC═CClH | (Z)-1-chloro-2,3,3,3-tetrafluoroprop-1- |
| | | ene |
| HCFO-1224yb | CHF₂CF═CClF | (E)-1-chloro-1,2,3,3-tetrafluoroprop-1- |
| | | ene |
| HCFO-1224yb | CHF₂CF═CClF | (Z)-1-chloro-1,2,3,3-tetrafluoroprop-1- |
| | | ene |
| HCFO-1224zc | CClF₂CH═CF₂ | 3-chloro-1,1,3,3-tetrafluoroprop-1-ene |
| HCFO-1224xc | CHF₂CCl═CF₂ | 2-chloro-1,1,3,3-tetrafluoroprop-1-ene |
| HCFO-1224ec | CHClFCF═CF₂ | 3-chloro-1,1,2,3-tetrafluoroprop-1-ene |
| HCFO-1233xf | CF₃CCl═CH₂ | 2-chloro-3,3,3-trifluoropropene |
| HCFO-E, Z-1233zd | E,Z-CF₃CH═CHCl | E,Z-1-chloro-3,3,3-trifluoropropene |
| HFO-1243zf | CF₃CH═CH₂ | 3,3,3-trifluoropropene |
| Z-HFO-1327mz | CF₃CF═CHCF₃ | 1,1,1,2,4,4,4-heptafluoro-2-butene |
| E-HFO-1327mz | CF₃CF═CHCF₃ | 1,1,1,2,4,4,4-heptafluoro-2-butene |
| HFO-1336ft (HFIB) | CH₂═C(CF₃)₂ | 3,3,3-trifluoro-2-(trifluoromethyl)prop-1- |
| | | ene (hexafluoroisobutylene) |
| E-HFO-1336mzz | E(trans)-CF₃CH═CHCF₃ | E(trans)-1,1,1,4,4,4-hexafluoro-2- |
| | | butene |
| Z-HFO-1336mzz | Z(cis)-CF₃CH═CHCF₃ | Z(cis)-1,1,1,4,4,4-hexafluoro-2-butene |

For refrigerant applications, such as use in air conditioning, heat pumps, refrigeration, and power cycles (e.g., organic Rankine cycles), the fluorinated compounds may provide improved solubility with refrigeration lubricants, such as mineral oils, alkylbenzenes, synthetic paraffins, synthetic naphthenes, poly(alpha)olefins, polyol esters (POE), polyalkylene glycols (PAG), polyvinyl ethers (PVE), or perfluoropolyethers (PFPE) or mixtures thereof.

In certain embodiments, fluorinated compounds may provide improved solubility for active ingredients in an aerosol or polymer constituents of a foam.

Fluorinated compounds may provide improved solubility for active ingredients in an aerosol propellant or polymer constituents of a foam.

Unsaturated fluorocarbons, such as E-HFO-1336mzz, exhibit different solubility than other typically used fluorocarbon propellants. Their reduced solubility can make it difficult to produce single phase aqueous homogenous aerosol formulations. The presence of low level certain fluorinated compounds can improve mixing and ease formulations and use of aerosol products.

Unsaturated fluorocarbons, such as E-HFO-1336mzz, also exhibit different solubility than other typically used blowing agents. Their reduced solubility can act to help seed small cell growth during the foaming reaction but they can be difficult to mix. The presence of fluorinated compounds may improve mixing and foam processing performance without sacrificing the benefits from the lower HFO solubility. Also, the fluorinated compounds may impart improved insulating performance to a foam insulation product.

For refrigerant applications, such as use in air conditioning, heat pumps, refrigeration, and power cycles (e.g., organic Rankine cycles), the fluorinated compounds may provide improved solubility with refrigeration lubricants, such as mineral oils, alkylbenzenes, synthetic paraffins, synthetic naphthenes, poly(alpha)olefins, polyol esters (POE), polyalkylene glycols (PAG), polyvinyl ethers (PVE), or perfluoropolyethers (PFPE) or mixtures thereof.

Further, certain fluorinated compounds may serve to improve leak detection ability. Leakage of refrigerants may lead to loss of refrigerant from a system, thus increasing cost of operation due to the need to top off refrigerant charge. And even minor loss of refrigerant from a system may impact proper operation. Finally, leakage of refrigerant may lead to excessive environmental contamination. In particular, fluorinated compounds, even at low levels can increase the detectability of refrigerant at the point of a leak. Thus, the system may be repaired or redesigned to prevent refrigerant leakage.

While the presence of fluorinated compounds (as defined herein) in a fluorobutene composition with E-1336mzz may enhance performance when the fluorobutene composition is used in many applications, the levels of fluorinated are kept low, for example, not so as to detract from the advantages of using E1336mzz in place of high GWP alternatives and other options.

### Applications

The fluorobutene compositions disclosed herein comprising E-HFO-1336mzz are useful as low global warming potential (GWP) heat transfer compositions, refrigerants, power cycle working fluids, aerosol propellants, foaming agents, blowing agents, solvents, cleaning agents, carrier fluids, displacement drying agents, buffing abrasion agents, polymerization media, expansion agents for poly-olefins and polyurethane, gaseous dielectrics, fire extinguishing agents, and fire suppression agents in liquid or gaseous form. The disclosed compositions can act as a working fluid used to carry heat from a heat source to a heat sink. Such heat transfer compositions may also be useful as a refrigerant in a cycle wherein the fluid undergoes a phase change, that is, from a liquid to a gas and back or vice versa.

Examples of heat transfer systems include but are not limited to air conditioners, freezers, refrigerators, heat pumps, water chillers, flooded evaporator chillers, direct expansion chillers, walk-in coolers, heat pumps, mobile refrigerators, mobile air conditioning units and combinations thereof.

In one embodiment, the compositions comprising E-HFO-1336mzz are useful in mobile heat transfer systems, including refrigeration, air conditioning, or heat pump systems or apparatus. In another embodiment, the compositions are useful in stationary heat transfer systems, including refrigeration, air conditioning, or heat pump systems or apparatus.

As used herein, mobile heat transfer systems refers to any refrigeration, air conditioner, or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “containers’ (combined sea/land transport) as well as “swap bodies” (combined road/rail transport).

As used herein, stationary heat transfer systems are systems that are fixed in place during operation. A stationary heat transfer system may be associated within or attached to buildings of any variety or may be stand-alone devices located out of doors, such as a soft drink vending machine. These stationary applications may be stationary air conditioning and heat pumps (including but not limited to chillers, high temperature heat pumps, including trans-critical heat pumps (with condenser temperatures above 50° C., 70° C., 80° C., 100° C., 120° C., 140° C., 160° C., 180° C., or 200° C.), residential, commercial or industrial air conditioning systems, and including window, ductless, ducted, packaged terminal, chillers, and those exterior but connected to the building such as rooftop systems). In stationary refrigeration applications, the disclosed compositions may be useful in high temperature, medium temperature and/or low temperature refrigeration equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the disclosed compositions may be used in supermarket refrigerator systems.

Therefore in accordance with the present invention, the compositions as disclosed herein containing E-HFO-1336mzz may be useful in methods for producing cooling, producing heating, and transferring heat.

In one embodiment, a method is provided for producing cooling comprising evaporating any of the present compositions comprising E-HFO-1336mzz in the vicinity of a body to be cooled, and thereafter condensing said composition.

In another embodiment, a method is provided for producing heating comprising condensing any of the present compositions comprising E-HFO-1336mzz in the vicinity of a body to be heated, and thereafter evaporating said compositions.

In another embodiment, disclosed is a method of using the present compositions comprising E-HFO-1336mzz as a heat transfer fluid composition. The method comprises transporting said composition from a heat source to a heat sink.

In many applications, some embodiments of the present compositions comprising E-HFO-1336mzz are useful as refrigerants and provide at least comparable cooling performance (meaning cooling capacity and energy efficiency) as the refrigerant for which a replacement is being sought. Additionally, the compositions of the present invention provide heating performance (meaning heating capacity and energy efficiency) comparable to a refrigerant being replaced.

In another embodiment, the compositions of the present invention comprising Z—HFO-1336mzz may be used to top-off a refrigerant charge in a chiller. For instance, if a chiller using HCFC-114 has diminished performance due to leakage of refrigerant, the compositions as disclosed herein may be added to bring performance back up to specification.

In another embodiment, a heat exchange system containing any of the present compositions comprising E-HFO-1336mzz is provided, wherein said system is selected from the group consisting of air conditioners, freezers, refrigerators, heat pumps, water chillers, flooded evaporator chillers, direct expansion chillers, walk-in coolers, heat pumps, mobile refrigerators, mobile air conditioning units, and systems having combinations thereof. Additionally, the compositions comprising E-HFO-1336mzz may be useful in secondary loop systems wherein these compositions serve as the primary refrigerant thus providing cooling to a secondary heat transfer fluid that thereby cools a remote location.

In one embodiment, there is provided a heat transfer system containing any of the present compositions comprising E-HFO-1336mzz. In another embodiment is disclosed a refrigeration, air-conditioning or heat pump apparatus containing any of the present compositions comprising E-HFO-1336mzz. In another embodiment, is disclosed a stationary refrigeration or air-conditioning apparatus containing any of the present compositions comprising E-HFO-1336mzz. In yet another embodiment is disclosed a mobile refrigeration or air conditioning apparatus containing a composition as disclosed herein.

In one embodiment, the present invention relates to a method for producing heating in a high temperature heat pump comprising condensing a vapor working fluid comprising compositions comprising E-HFO-1336mzz, in a condenser, thereby producing a liquid working fluid. Said high temperature heat pump may operate at a condenser temperature of at least about 100° C.

Said high temperature heat pump may comprise a centrifugal compressor or positive displacement compressor.

The method for producing heating may further comprise passing a heat transfer medium through the condenser, whereby said condensation of working fluid heats the heat transfer medium, and passing the heated heat transfer medium from the condenser to a body to be heated.

A body to be heated may be any space, object or fluid that may be heated such as water or air for space heating. In one embodiment, a body to be heated may be a room, building, or the passenger compartment of an automobile. Alternatively, in another embodiment, a body to be heated may be a second or the medium or heat transfer fluid, such as a chemical process stream.

In accordance with this invention, a method is provided for converting heat from a heat source to mechanical energy. This method comprises heating a working fluid using heat supplied from the heat source; and expanding the heated working fluid to lower the pressure of the working fluid and generate mechanical energy as the pressure of the working fluid is lowered. The method is characterized by using a working fluid comprising a fluorobutene composition disclosed herein. The method for converting heat from a heat source to mechanical energy is a power cycle and may be an organic Rankine cycle (ORC).

The method is provided for converting heat from a heat source to mechanical energy may be a may be a sub-critical power cycle in which the organic working fluid used in the cycle receives heat at a pressure lower than the critical pressure of the organic working fluid and the working fluid remains below its critical pressure throughout the entire cycle.

The method is provided for converting heat from a heat source to mechanical energy may be a trans-critical power cycle, in which the organic working fluid used in the cycle receives heat at a pressure higher than the critical pressure of the organic working fluid. In a trans-critical cycle, the working fluid is compressed to a pressure above its critical pressure prior to being heated, and then during expansion the working fluid pressure is reduced to below its critical pressure.

The method is provided for converting heat from a heat source to mechanical energy may be a super-critical power cycle. In a super critical cycle, the working fluid remains above its critical pressure for the complete cycle (e.g., compression, heating, expansion and cooling).

In another embodiment, the present invention relates to foam expansion agent compositions comprising E-HFO-1336mzz for use in preparing foams. In other embodiments the invention provides foamable compositions, and preferably thermoset (like polyurethane, polyisocyanurate, or phenolic) foam compositions, and thermoplastic (like polystyrene, polyethylene, or polypropylene) foam compositions and method of preparing foams. In such foam embodiments, one or more of the present compositions comprising E-HFO-1336mzz are included as a foam expansion agent in foamable compositions, which composition preferably includes one or more additional components capable of reacting and/or mixing and foaming under the proper conditions to form a foam or cellular structure.

A process for preparing a thermoplastic foam is disclosed herein such process comprising providing a foamable composition comprising a thermoplastic polymer and a blowing agent, wherein the blowing agent comprises a fluorobutene composition comprising E-HFO-1336mzz. Said thermoplastic polymer comprises polystyrene homopolymer, polystyrene copolymer, styrene-acrylonitrile copolymer or a blend of two or more thereof and expanding said foamable composition to produce a closed shell polymer foam.

The foamable composition for preparing a thermoplastic foam may further comprise a co-blowing agent, nucleating agent, flame retardant, cell stabilizer agent, surfactant, preservative colorant, antioxidant, reinforcing agent, filler, antistatic agent, IR attenuating agent, extrusion aid, plasticizer, viscosity modifier, and other known additives, all in the amount to obtain the effect desired. Examples of nucleating agent are talc, graphite and magnesium silicate. Examples of flame retardants include tetrabromo-bis phenol A and polymeric flame retardants.

A process for preparing a polyurethane or polyisocyanurate foam is disclosed herein such process comprising reacting polyisocyanate with an active hydrogen-containing compound in the presence of blowing agent comprising a compositions comprising E-HFO-1336mzz, to obtain said foamed reaction product. Examples of active hydrogen-containing compounds include polyols, such as polyether or polyester polyols. Some of the hydroxyl groups can be replaced by amine groups, whereby the active hydrogen-containing compound contains both hydroxyl and amine groups. While any suitable polyisocyanate can be employed in the instant process, examples of polyisocyanates useful for making polyisocyanate-based foam comprise at least one of aromatic, aliphatic and cycloaliphatic polyisocyanates, among others.

Typically, before reacting with a suitable polyisocyanate, the active hydrogen-containing compound and optionally other additives are mixed with the blowing agent to form a foam-forming composition. Such foam-forming composition is typically known in the art as an isocyanate-reactive preblend, or B-side composition. The B-side composition contains the active hydrogen-containing compound and preferably also contains the blowing agent composition of the present invention. The A-side composition comprises the polyisocyanate. The foam-forming composition comprising the A-side composition and the B-side composition can be prepared in any manner convenient to one skilled in this art, including simply weighing desired quantities of each component (ingredient) and, thereafter, combining them in an appropriate container at the temperatures and pressures desired.

It is often desirable to employ minor amounts of additives in the B-side composition. Among these additives comprise one or more members from the group consisting of catalysts, surfactants, flame retardants such as TCPP, preservatives, colorants, antioxidants, reinforcing agents, filler, and antistatic agents, among others well known in this art.

In the process of making a polyurethane-based or polyisocyanurate-based foam or polyurethane/polyisocyanurate-based foam, the active hydrogen-containing compound, polyisocyanate and other components are contacted, thoroughly mixed, and permitted to expand and cure into a cellular polymer.

Another embodiment of the present invention relates to the use of the compositions of the present invention comprising E-HFO-1336mzz as propellants in sprayable compositions. Additionally, the present invention relates to a sprayable fluorobutene composition comprising E-HFO-1336mzz. The active ingredient to be sprayed together with inert ingredients, solvents and other materials may also be present in a sprayable composition. In one embodiment, a sprayable composition is an aerosol. The present compositions can be used to formulate a variety of industrial aerosols or other sprayable compositions such as contact cleaners, dusters, lubricant sprays, mold release sprays, insecticides, and the like, and consumer aerosols such as personal care products (such as, e.g., hair sprays, deodorants, and perfumes), household products (such as, e.g., waxes, polishes, pan sprays, room fresheners, and household insecticides), and automotive products (such as, e.g., cleaners and polishers), as well as medicinal materials such as anti-asthma and anti-halitosis medications. Examples of this includes metered dose inhalers (MDIs) for the treatment of asthma and other chronic obstructive pulmonary diseases and for delivery of medicaments to accessible mucous membranes or intra-nasally

The present invention further relates to a process for producing aerosol products comprising the step of adding a fluorobutene composition of the present invention comprising E-HFO-1336mzz to a formulation, including active, ingredients in an aerosol container, wherein said composition functions as a propellant. Additionally, the present invention further relates to a process for producing aerosol products comprising the step of adding a fluorobutene composition of the present invention comprising E-HFO-1336mzz to a barrier type aerosol package (like a bag-in-a-can or piston can) wherein said composition is kept separated from other formulation ingredients in an aerosol container, and wherein said composition functions as a propellant. Additionally, the present invention further relates to a process for producing aerosol products comprising the step of adding only a fluorobutene composition of the present invention comprising E-HFO-1336mzz to an aerosol package, wherein said composition functions as the active ingredient (e.g., a duster, or a cooling or freezing spray).

Also provided is a method for detecting a leak from a container comprising sampling the air in the vicinity of the container and detecting at least one fluorinated compound with means for detecting the leak, wherein the fluorobutene composition of the present invention comprising HFO-1336mzz-E is contained inside the container.

A container may be any known container or system or apparatus that is filled with the fluorobutene composition comprising 1336mzz-E. A container may include but is not limited to a storage container, a transport container, an aerosol can, a fire extinguishing system, a chiller apparatus, a heat pump apparatus, heat transfer container, and a power cycle apparatus (e.g., an organic Rankine cycle system).

Means for detecting a leak may be any known sensor designed to detect leaks. In particular, means for detecting the leak includes, but is not limited to, electrochemical, corona discharge and mass spectroscopic leak detectors.

By “in the vicinity of” the container is meant within 12 inches of the outside surface of the container. Alternatively, in the vicinity may be within 6 inches, within 3 inches or within one inch of the outside surface of the container.

Without further elaboration, it is believed that one skilled in the art can, using the description herein, utilize the present invention to its fullest extent. The following specific embodiments are, therefore, to be construed as merely illustrative, and do not constrain the remainder of the disclosure in any way whatsoever.

### SELECTED EMBODIMENTS

1. This Embodiment is a fluorobutene composition comprising E-1,1,1,4,4,4-hexafluoro-2-butene and a fluorinated compound selected from the group consisting of 1,1,1,2,4,4,4-heptafluorobutane, 1,1,1,3,3-pentafluoropropane, 2-chloro-1,1,1-trifluoroethane, E-1-chloro-3,3,3-trifluoropropene, Z-1-chloro-3,3,3-trifluoropropene, and 2-chloro-3,3,3-trifluoropropene, wherein the composition comprises at least 99% by weight E-1,1,1,4,4,4-hexafluoro-2-butene.
2. The composition of Embodiment 1 wherein the fluorinated compound is present in an amount of 0.0001 to 0.9 wt %.
3. The composition of Embodiment 1 wherein the fluorinated compound is present in an amount of 0.0005 to 0.4 wt %.
4. The composition of Embodiment 1 wherein the fluorinated compound is present in an amount of 0.005 to 0.2 wt %.
5. The composition of any one of Embodiments 1-4, further comprising a compound selected from the group consisting of vinyl chloride, 3,3,3-trifluoro-2-(trifluoromethyl)prop-1-ene, 1,1,1,2,4,4,4-heptafluoro-2-butene, and 1,1,1,4,4,4-hexafluorobutane.
6. The composition of any one of Embodiments 1-5, further comprising Z-1,1,1,4,4,4-hexafluoro-2-butene.
7. The composition of Embodiment 6, comprising 1,1,1,2,4,4,4-heptafluorobutane.
8. The composition of Embodiment 6, comprising 2-chloro-1,1,1-trifluoroethane.
9. The composition of Embodiment 6, comprising E-1-chloro-3,3,3-trifluoropropene, Z-1-chloro-3,3,3-trifluoropropene, 2-chloro-3,3,3-trifluoropropene, or mixtures of two or more thereof.
10. The composition of any of Embodiments 1-9, wherein the composition comprises less than 0.1% by weight of 3,3,3-trifluoro-2-(trifluoromethyl)prop-1-ene.
11. The composition of any of Embodiments 1-9, wherein the composition comprises less than 0.01% by weight of vinyl chloride.
12. The composition of any of Embodiments 1-9, wherein the composition comprises less than 0.1% by weight of 3,3,3-trifluoro-2-(trifluoromethyl)prop-1-ene and less than 0.01% by weight of vinyl chloride.
13. This embodiment is a fluorobutene composition comprising E-1,1,1,4,4,4-hexafluoro-2-butene, Z-1,1,1,4,4,4-hexafluoro-2-butene, 1,1,1,2,4,4,4-heptafluorobutane, 2-chloro-1,1,1-trifluoroethane, E-1-chloro-3,3,3-trifluoropropene, Z-1-chloro-3,3,3-trifluoropropene, and 2-chloro-3,3,3-trifluoropropene, wherein the composition comprises greater than 99% by weight E-1,1,1,4,4,4-hexafluoro-2-butene.
14. This embodiment is a fluorobutene composition comprising E-1,1,1,4,4,4-hexafluoro-2-butene and at least two fluorinated compounds selected from the group consisting of 1,1,1,3,3-pentafluoropropane, 2-chloro-1,1,1-trifluoroethane, E-1-chloro-3,3,3-trifluoropropene, Z-1-chloro-3,3,3-trifluoropropene, 2-chloro-3,3,3-trifluoropropene, 3,3,3-trifluoro-2-(trifluoromethyl)prop-1-ene, 1,1,1,2,4,4,4-heptafluoro-2-butene.
15. The fluorobutene composition of Embodiment 15, wherein the composition comprises:
1,1,1,3,3-pentafluoropropane and 2-chloro-1,1,1-trifluoroethane, or
1,1,1,3,3-pentafluoropropane and E-1-chloro-3,3,3-trifluoropropene, or
1,1,1,3,3-pentafluoropropane and Z-1-chloro-3,3,3-trifluoropropene, or
1,1,1,3,3-pentafluoropropane and 2-chloro-3,3,3-trifluoropropene, or
1,1,1,3,3-pentafluoropropane and 3,3,3-trifluoro-2-(trifluoromethyl)prop-1-ene, or
1,1,1,3,3-pentafluoropropane and 1,1,1,2,4,4,4-heptafluoro-2-butene, or
2-chloro-1,1,1-trifluoroethane and E-1-chloro-3,3,3-trifluoropropene, or
2-chloro-1,1,1-trifluoroethane and Z-1-chloro-3,3,3-trifluoropropene, or
2-chloro-1,1,1-trifluoroethane and 2-chloro-3,3,3-trifluoropropene, or
2-chloro-1,1,1-trifluoroethane and 3,3,3-trifluoro-2-(trifluoromethyl)prop-1-ene, or
2-chloro-1,1,1-trifluoroethane and 1,1,1,2,4,4,4-heptafluoro-2-butene.
   16. This embodiment is a fluorobutene composition comprising E-1,1,4,4,4-hexafluoro-2-butene and at least three fluorinated compounds selected from the group consisting of 1,1,1,3,3-pentafluoropropane, 2-chloro-1,1,1-trifluoroethane, E-1-chloro-3,3,3-trifluoropropene, Z-1-chloro-3,3,3-trifluoropropene, 2-chloro-3,3,3-trifluoropropene, 3,3,3-trifluoro-2-(trifluoromethyl)prop-1-ene, 1,1,1,2,4,4,4-heptafluoro-2-butene (1327mz).
   17. The fluorobutene composition of Embodiment 16, wherein the composition comprises:
1,1,1,3,3-pentafluoropropane, 2-chloro-1,1,1-trifluoroethane, and Z-1-chloro-3,3,3-trifluoropropene, or
1,1,1,3,3-pentafluoropropane, 2-chloro-1,1,1-trifluoroethane, and E-1-chloro-3,3,3-trifluoropropene, or
1,1,1,3,3-pentafluoropropane, 2-chloro-1,1,1-trifluoroethane, and 2-chloro-3,3,3-trifluoropropene, or
1,1,1,3,3-pentafluoropropane, 2-chloro-1,1,1-trifluoroethane, and 3,3,3-trifluoro-2-(trifluoromethyl)prop-1-ene, or
1,1,1,3,3-pentafluoropropane, 2-chloro-1,1,1-trifluoroethane, and 1,1,1,2,4,4,4-heptafluoro-2-butene, or
1,1,1,3,3-pentafluoropropane, E-1-chloro-3,3,3-trifluoropropene, and Z-1-chloro-3,3,3-trifluoropropene, or
1,1,1,3,3-pentafluoropropane, E-1-chloro-3,3,3-trifluoropropene, and 2-chloro-3,3,3-trifluoropropene, or
1,1,1,3,3-pentafluoropropane, E-1-chloro-3,3,3-trifluoropropene, and 3,3,3-trifluoro-2-(trifluoromethyl)prop-1-ene, or
1,1,1,3,3-pentafluoropropane, E-1-chloro-3,3,3-trifluoropropene, and 1,1,1,2,4,4,4-heptafluoro-2-butene, or
1,1,1,3,3-pentafluoropropane, Z-1-chloro-3,3,3-trifluoropropene, and 2-chloro-3,3,3-trifluoropropene, or
1,1,1,3,3-pentafluoropropane, Z-1-chloro-3,3,3-trifluoropropene, and 3,3,3-trifluoro-2-(trifluoromethyl)prop-1-ene, or
1,1,1,3,3-pentafluoropropane, Z-1-chloro-3,3,3-trifluoropropene, and 1,1,1,2,4,4,4-heptafluoro-2-butene, or
2-chloro-1,1,1-trifluoroethane, E-1-chloro-3,3,3-trifluoropropene, and Z-1-chloro-3,3,3-trifluoropropene, or
2-chloro-1,1,1-trifluoroethane, E-1-chloro-3,3,3-trifluoropropene, and 2-chloro-3,3,3-trifluoropropene, or
2-chloro-1,1,1-trifluoroethane, E-1-chloro-3,3,3-trifluoropropene, and 3,3,3-trifluoro-2-(trifluoromethyl)prop-1-ene, or
2-chloro-1,1,1-trifluoroethane, E-1-chloro-3,3,3-trifluoropropene, and 1,1,1,2,4,4,4-heptafluoro-2-butene, or
2-chloro-1,1,1-trifluoroethane, Z-1-chloro-3,3,3-trifluoropropene, and 2-chloro-3,3,3-trifluoropropene, or
2-chloro-1,1,1-trifluoroethane, Z-1-chloro-3,3,3-trifluoropropene, and 3,3,3-trifluoro-2-(trifluoromethyl)prop-1-ene, or
2-chloro-1,1,1-trifluoroethane, Z-1-chloro-3,3,3-trifluoropropene, and 1,1,1,2,4,4,4-heptafluoro-2-butene, or
2-chloro-1,1,1-trifluoroethane, 2-chloro-3,3,3-trifluoropropene, and 3,3,3-trifluoro-2-(trifluoromethyl)prop-1-ene, or
2-chloro-1,1,1-trifluoroethane, 2-chloro-3,3,3-trifluoropropene, and 1,1,1,2,4,4,4-heptafluoro-2-butene, or
2-chloro-1,1,1-trifluoroethane, 3,3,3-trifluoro-2-(trifluoromethyl)prop-1-ene, and 1,1,1,2,4,4,4-heptafluoro-2-butene, or
E-1-chloro-3,3,3-trifluoropropene, Z-1-chloro-3,3,3-trifluoropropene, and 2-chloro-3,3,3-trifluoropropene, or
E-1-chloro-3,3,3-trifluoropropene, Z-1-chloro-3,3,3-trifluoropropene, and 3,3,3-trifluoro-2-(trifluoromethyl)prop-1-ene, or
E-1-chloro-3,3,3-trifluoropropene, Z-1-chloro-3,3,3-trifluoropropene, and 1,1,1,2,4,4,4-heptafluoro-2-butene, or
E-1-chloro-3,3,3-trifluoropropene, 2-chloro-3,3,3-trifluoropropene, and 3,3,3-trifluoro-2-(trifluoromethyl)prop-1-ene, or
Z-1-chloro-3,3,3-trifluoropropene, 2-chloro-3,3,3-trifluoropropene, and 3,3,3-trifluoro-2-(trifluoromethyl)prop-1-ene, or
Z-1-chloro-3,3,3-trifluoropropene, 3,3,3-trifluoro-2-(trifluoromethyl)prop-1-ene, and 1,1,1,2,4,4,4-heptafluoro-2-butene.
   18. The fluorobutene composition of any one of Embodiments 1 to 17, further comprising a lubricant selected from the group consisting of mineral oils, such as paraffins, naphthenes and aromatics, alkylaryls, such as linear and branched alkyl alkylbenzenes, synthetic paraffins, synthetic naphthenes, poly(alphaolefins), polyol esters, polyalkylene glycols, and polyvinyl ethers.
   19. This embodiment is a method of forming a foam comprising: (a) adding to a foamable composition a composition of any of Embodiments 1 through 17; and (b) processing the foamable composition under conditions effective to form a foam.
   20. This embodiment is a process for preparing a thermoplastic foam comprising providing a foamable composition comprising a thermoplastic polymer and a blowing agent, wherein the blowing agent comprises a composition of any of Embodiments 1 through 17.
   21. This embodiment is a process for preparing a polyurethane or polyisocyanurate foam comprising reacting polyisocyanate with an active hydrogen-containing compound in the presence of blowing agent comprising a composition of any of Embodiments 1 through 17, to obtain said foamed reaction product.
   22. This Embodiment is a process for producing aerosol products comprising the step of adding a composition of any of Embodiments 1 through 17 to a formulation, including active ingredients in an aerosol container, wherein said composition functions as a propellant.
   23. This Embodiment is a process for treating a surface, comprising: providing a surface; and contacting the surface with a treatment composition;
      wherein the surface includes a treatable material deposited thereon; and
      wherein the treatment composition comprises the fluorobutene composition of any one of Embodiments 1 to 17.
   24. The process of Embodiment 23, wherein the treatment composition substantially dissolves the treatable material.
   25. This Embodiment is a process for forming a composition comprising: providing a solute; and contacting the solute with a solvent;
      wherein the solvent comprises the fluorobutene composition of any one of Embodiments 1 to 17.
   26. This Embodiment is a method for producing cooling comprising evaporating a composition of any one of Embodiments 1 to 18 in the vicinity of a body to be cooled, and thereafter condensing said composition.
   27. This Embodiment is a method for producing heat comprising condensing a composition of any of Embodiments 1 through 18 in the vicinity of a body to be heated, and thereafter evaporating said compositions.
   28. This Embodiment is a process for transferring heat, comprising providing an article; and contacting the article with a heat transfer media;
      wherein the heat transfer media comprises the fluorobutene composition of any one of Embodiments 1 to 18.
   29. This Embodiment is a process for converting heat to mechanical energy comprising heating a working fluid comprising the composition of any of Embodiments 1 through 18 and thereafter expanding the heated working fluid.
   30. This Embodiment is a refrigeration system, comprising: an evaporator; a condenser; a compressor; an expansion device; and a heat transfer medium;
      wherein the heat transfer medium comprises the fluorobutene composition of any one of Embodiments 1 to 18.
   31. This Embodiment is a chiller apparatus comprising the fluorobutene composition of any one of Embodiments 1 to 18.
   32. The fluorobutene composition of any one of Embodiments 1 to 18 for use in a chiller apparatus, preferably in a medium temperature chiller apparatus.
   33. This Embodiment is use of the fluorobutene composition of any one of Embodiments 1 to 18 in a chiller apparatus, preferably in a medium temperature chiller apparatus.
   34. This Embodiment is a method of producing cooling, the method comprising: evaporating the composition of any one of Embodiments 1 to 18 in the vicinity of a body to be cooled and thereafter condensing the composition.
   35. This Embodiment is a refrigeration apparatus, air-conditioning apparatus, or heat pump apparatus containing the composition of any one of Embodiments 1 to 18, wherein the refrigeration apparatus preferably is a stationary or mobile refrigeration apparatus and the air-conditioning apparatus preferably is a mobile air-conditioning apparatus, more preferably an automobile air-conditioning apparatus.
   36. This Embodiment is a method for producing heating in a high temperature heat pump comprising condensing a vapor working fluid comprising the composition of any one of Embodiments 1 to 18, in a condenser, thereby producing a liquid working fluid.
   37. This Embodiment is a method comprises heating a working fluid using heat supplied from the heat source; and expanding the heated working fluid to lower the pressure of the working fluid and generate mechanical energy as the pressure of the working fluid is lowered, wherein the method is characterized by using a working fluid comprising the composition of any one of Embodiments 1 to 17.

### EXAMPLES

Materials. The materials used to prepare the Examples are commercially available or may be prepared by known methods.

### Examples 1-4. Preparation of E1336MZZ with Fluorinated Compounds

E-HFO-1336mzz is prepared as follows. An Inconel® pipe (0.5 inch (1.27 cm) OD, 10 inch (25.4 cm) length, 0.35 in (0.89 cm wall thickness) is the reactor and was filled with 6 cc of chrome catalyst. The catalyst is activated with HF. The reactor is run at 80 psig. HCFC-343jfd and HF are fed at 1/20 mol ratio. The contact time is 20 seconds.

Fluorobutene compositions comprising E1336 with the fluorinated compounds as set forth in Table 2, are prepared with the added compounds in the amounts provided.

TABLE 2
Compositions of Examples 1-4

| | Example 1 | Example 2 | Example 3 | Example 4 |
|---|---|---|---|---|
| Compound | wt % | wt % | wt % | wt % |
| E-HFO-1336mzz | 99.9 | 99.9 | 99.9 | 99.9 |
| Z-HFO-1336mzz | 0 | 0 | 0.001 | 0.001 |
| HCFO-1233xf | 0.01 | 0.01 | 0.01 | 0.015 |
| HFO-1336ft | 0.025 | 0.024 | 0.01 | 0.01 |
| HCFC-133a | 0.02 | 0.035 | 0.05 | 0.035 |
| HCO-1140 | 0 | 0 | 0 | 0.0001 |
| E-HCFO-1233zd | 0.0013 | 0.001 | 0.002 | 0.0007 |
| HFC-245fa | 0.01 | 0.008 | 0.009 | 0.007 |
| HFC-347mef | 0.0001 | 0 | 0.001 | 0 |
| HFO-1327mz | 0.03 | 0.02 | 0.01 | 0.03 |
| HFO-1243zf | 0.0036 | 0.002 | 0.007 | 0.0012 |

### Example 5. Performance Testing

Compositions are prepared by mixing the components in the amounts as recited and the refrigeration performances of these compositions were determined and are provided in Tables 3 and 4.

Cycle Input Parameters:
Evaporator Average Temperature=4.44° C.
Evaporator Superheat (K)=6
Suction Line Superheat (K)=0
Condenser Average Temperature=37.78° C.
Subcooling (K)=0
Compressor Isentropic Efficiency=0.85
Compressor Volumetric Efficiency=0.95

Glide is defined as the average of evaporator glide and condenser glide.

Average dipole moment and GWP are calculated using a weighted average.

TABLE 3
Performance of E1233zd-E1336mzz Compositions

| | | | Average | Discharge | Suction | Discharge |
|---|---|---|---|---|---|---|
| E1233zd, | E1336mzz, | | Glide | Temperature | Pressure | Pressure |
| wt % | wt % | GWP | (K) | (° C.) | (MPa) | (MPa) |
| 0.01 | 0.99 | 1 | 0.021 | 39.6 | 0.088 | 0.296 |
| 0.1 | 0.9 | 1 | 0.16 | 40.3 | 0.085 | 0.287 |
| 0.2 | 0.8 | 1 | 0.29 | 41.0 | 0.083 | 0.279 |
| 0.3 | 0.7 | 1 | 0.43 | 41.8 | 0.08 | 0.27 |
| 0.4 | 0.6 | 1 | 0.63 | 42.6 | 0.077 | 0.262 |
| 0.5 | 0.5 | 1 | 0.86 | 43.5 | 0.075 | 0.253 |
| 0.6 | 0.4 | 1 | 1.07 | 44.4 | 0.072 | 0.244 |
| 0.7 | 0.3 | 1 | 1.20 | 45.2 | 0.068 | 0.234 |
| 0.8 | 0.2 | 1 | 1.13 | 46.0 | 0.065 | 0.224 |
| 0.9 | 0.1 | 1 | 0.77 | 46.6 | 0.062 | 0.213 |
| 0.99 | 0.01 | 1 | 0.10 | 47.0 | 0.059 | 0.202 |
| 1 | 0 | 1 | 0.00 | 47.0 | 0.058 | 0.201 |

| | | | | Average | COP |
|---|---|---|---|---|---|
| | | | | Dipole | relative |
| E1233zd, | E1336mzz, | Capacity | | moment | to |
| wt % | wt % | (kJ/m³) | COP | (Debye) | E1336mzz |
| 0.01 | 0.99 | 756 | 5.96 | 0.03 | 100.1% |
| 0.1 | 0.9 | 740 | 5.99 | 0.16 | 100.7% |
| 0.2 | 0.8 | 725 | 6.03 | 0.30 | 101.3% |
| 0.3 | 0.7 | 709 | 6.06 | 0.44 | 101.8% |
| 0.4 | 0.6 | 692 | 6.09 | 0.58 | 102.4% |
| 0.5 | 0.5 | 673 | 6.12 | 0.73 | 102.9% |
| 0.6 | 0.4 | 652 | 6.15 | 0.87 | 103.4% |
| 0.7 | 0.3 | 630 | 6.18 | 1.01 | 103.8% |
| 0.8 | 0.2 | 605 | 6.20 | 1.15 | 104.3% |
| 0.9 | 0.1 | 578 | 6.23 | 1.30 | 104.6% |
| 0.99 | 0.01 | 553 | 6.25 | 1.43 | 105.0% |
| 1 | 0 | 550 | 6.25 | 1.44 | 100.0% |

TABLE 4
Performance of E1233zd-E1336mzz-Z1336mzz Compositions

| | | | | Average | Discharge | Suction |
|---|---|---|---|---|---|---|
| E1233zd, | E1336mzz, | Z1336mzz, | | Glide | Temperature | Pressure |
| wt % | wt % | wt % | GWP | (K) | (° C.) | (MPa) |
| 0.01 | 0.01 | 0.98 | 1.98 | 0.45 | 40.9 | 0.031 |
| 0.01 | 0.98 | 0.01 | 1.01 | 0.13 | 39.7 | 0.087 |
| 0.1 | 0.1 | 0.8 | 1.8 | 3.30 | 42.9 | 0.038 |
| 0.1 | 0.2 | 0.7 | 1.7 | 4.40 | 43.4 | 0.043 |
| 0.1 | 0.3 | 0.6 | 1.6 | 5.02 | 43.6 | 0.047 |
| 0.1 | 0.4 | 0.5 | 1.5 | 5.15 | 43.6 | 0.052 |
| 0.1 | 0.5 | 0.4 | 1.4 | 4.79 | 43.3 | 0.058 |
| 0.1 | 0.6 | 0.3 | 1.3 | 3.96 | 42.7 | 0.064 |
| 0.1 | 0.7 | 0.2 | 1.2 | 2.75 | 42.0 | 0.071 |
| 0.1 | 0.8 | 0.1 | 1.1 | 1.36 | 41.1 | 0.078 |
| 0.2 | 0.1 | 0.7 | 1.7 | 3.71 | 43.7 | 0.042 |
| 0.2 | 0.2 | 0.6 | 1.6 | 4.35 | 43.9 | 0.047 |
| 0.2 | 0.3 | 0.5 | 1.5 | 4.55 | 43.9 | 0.052 |
| 0.2 | 0.4 | 0.4 | 1.4 | 4.29 | 43.7 | 0.057 |
| 0.2 | 0.5 | 0.3 | 1.3 | 3.60 | 43.2 | 0.063 |
| 0.2 | 0.6 | 0.2 | 1.2 | 2.55 | 42.5 | 0.069 |
| 0.2 | 0.7 | 0.1 | 1.1 | 1.33 | 41.7 | 0.076 |
| 0.3 | 0.1 | 0.6 | 1.6 | 3.56 | 44.2 | 0.046 |
| 0.3 | 0.2 | 0.5 | 1.5 | 3.87 | 44.3 | 0.051 |
| 0.3 | 0.3 | 0.4 | 1.4 | 3.75 | 44.1 | 0.056 |
| 0.3 | 0.4 | 0.3 | 1.3 | 3.22 | 43.7 | 0.062 |
| 0.3 | 0.5 | 0.2 | 1.2 | 2.36 | 43.1 | 0.068 |
| 0.3 | 0.6 | 0.1 | 1.1 | 1.33 | 42.4 | 0.074 |
| 0.4 | 0.1 | 0.5 | 1.5 | 3.03 | 44.5 | 0.05 |
| 0.4 | 0.2 | 0.4 | 1.4 | 3.11 | 44.5 | 0.055 |
| 0.4 | 0.3 | 0.3 | 1.3 | 2.80 | 44.2 | 0.06 |
| 0.4 | 0.4 | 0.2 | 1.2 | 2.16 | 43.7 | 0.066 |
| 0.4 | 0.5 | 0.1 | 1.1 | 1.35 | 43.1 | 0.072 |
| 0.5 | 0.1 | 0.4 | 1.4 | 2.32 | 44.7 | 0.053 |
| 0.5 | 0.2 | 0.3 | 1.3 | 2.29 | 44.6 | 0.058 |
| 0.5 | 0.3 | 0.2 | 1.2 | 1.93 | 44.3 | 0.064 |
| 0.5 | 0.4 | 0.1 | 1.1 | 1.38 | 43.9 | 0.069 |
| 0.6 | 0.1 | 0.3 | 1.3 | 1.62 | 45.0 | 0.056 |
| 0.6 | 0.2 | 0.2 | 1.2 | 1.61 | 44.8 | 0.061 |
| 0.6 | 0.3 | 0.1 | 1.1 | 1.37 | 44.6 | 0.067 |
| 0.7 | 0.1 | 0.2 | 1.2 | 1.10 | 45.3 | 0.059 |
| 0.7 | 0.2 | 0.1 | 1.1 | 1.22 | 45.3 | 0.064 |
| 0.8 | 0.1 | 0.1 | 1.1 | 0.82 | 45.9 | 0.061 |
| 0.98 | 0.01 | 0.01 | 1.01 | 0.10 | 46.9 | 0.059 |
| 1 | 0 | 0 | 1 | 0.00 | 47.0 | 0.058 |

| | | | | | | Average | COP |
|---|---|---|---|---|---|---|---|
| | | | Discharge | | | Dipole | relative |
| E1233zd, | E1336mzz, | Z1336mzz, | Pressure | Capacity | | moment | to |
| wt % | wt % | wt % | (MPa) | (kJ/m³) | COP | (Debye) | E1336mzz |
| 0.01 | 0.01 | 0.98 | 0.121 | 315 | 6.15 | 2.88 | 103.4% |
| 0.01 | 0.98 | 0.01 | 0.294 | 751 | 5.958 | 0.06 | 100.1% |
| 0.1 | 0.1 | 0.8 | 0.146 | 382 | 6.144 | 2.48 | 103.3% |
| 0.1 | 0.2 | 0.7 | 0.161 | 420 | 6.139 | 2.19 | 103.2% |
| 0.1 | 0.3 | 0.6 | 0.177 | 461 | 6.132 | 1.90 | 103.1% |
| 0.1 | 0.4 | 0.5 | 0.193 | 503 | 6.12 | 1.61 | 102.9% |
| 0.1 | 0.5 | 0.4 | 0.21 | 547 | 6.099 | 1.32 | 102.5% |
| 0.1 | 0.6 | 0.3 | 0.228 | 593 | 6.071 | 1.03 | 102.0% |
| 0.1 | 0.7 | 0.2 | 0.248 | 642 | 6.04 | 0.74 | 101.5% |
| 0.1 | 0.8 | 0.1 | 0.268 | 692 | 6.014 | 0.45 | 101.1% |
| 0.2 | 0.1 | 0.7 | 0.159 | 417 | 6.159 | 2.33 | 103.5% |
| 0.2 | 0.2 | 0.6 | 0.174 | 456 | 6.149 | 2.04 | 103.3% |
| 0.2 | 0.3 | 0.5 | 0.189 | 497 | 6.136 | 1.75 | 103.1% |
| 0.2 | 0.4 | 0.4 | 0.206 | 540 | 6.117 | 1.46 | 102.8% |
| 0.2 | 0.5 | 0.3 | 0.223 | 584 | 6.094 | 1.17 | 102.4% |
| 0.2 | 0.6 | 0.2 | 0.242 | 631 | 6.068 | 0.88 | 102.0% |
| 0.2 | 0.7 | 0.1 | 0.26 | 679 | 6.046 | 0.59 | 101.6% |
| 0.3 | 0.1 | 0.6 | 0.17 | 450 | 6.165 | 2.19 | 103.6% |
| 0.3 | 0.2 | 0.5 | 0.185 | 490 | 6.151 | 1.89 | 103.4% |
| 0.3 | 0.3 | 0.4 | 0.201 | 531 | 6.135 | 1.60 | 103.1% |
| 0.3 | 0.4 | 0.3 | 0.218 | 574 | 6.116 | 1.31 | 102.8% |
| 0.3 | 0.5 | 0.2 | 0.236 | 619 | 6.095 | 1.02 | 102.4% |
| 0.3 | 0.6 | 0.1 | 0.253 | 665 | 6.077 | 0.73 | 102.1% |
| 0.4 | 0.1 | 0.5 | 0.181 | 480 | 6.168 | 2.04 | 103.7% |
| 0.4 | 0.2 | 0.4 | 0.196 | 521 | 6.153 | 1.75 | 103.4% |
| 0.4 | 0.3 | 0.3 | 0.212 | 563 | 6.138 | 1.46 | 103.2% |
| 0.4 | 0.4 | 0.2 | 0.229 | 606 | 6.122 | 1.17 | 102.9% |
| 0.4 | 0.5 | 0.1 | 0.246 | 650 | 6.107 | 0.87 | 102.6% |
| 0.5 | 0.1 | 0.4 | 0.19 | 507 | 6.173 | 1.89 | 103.7% |
| 0.5 | 0.2 | 0.3 | 0.206 | 549 | 6.16 | 1.60 | 103.5% |
| 0.5 | 0.3 | 0.2 | 0.222 | 591 | 6.148 | 1.31 | 103.3% |
| 0.5 | 0.4 | 0.1 | 0.238 | 633 | 6.136 | 1.02 | 103.1% |
| 0.6 | 0.1 | 0.3 | 0.198 | 532 | 6.183 | 1.74 | 103.9% |
| 0.6 | 0.2 | 0.2 | 0.214 | 573 | 6.173 | 1.45 | 103.7% |
| 0.6 | 0.3 | 0.1 | 0.229 | 614 | 6.163 | 1.16 | 103.6% |
| 0.7 | 0.1 | 0.2 | 0.205 | 552 | 6.197 | 1.59 | 104.2% |
| 0.7 | 0.2 | 0.1 | 0.22 | 592 | 6.188 | 1.30 | 104.0% |
| 0.8 | 0.1 | 0.1 | 0.21 | 568 | 6.212 | 1.45 | 104.4% |
| 0.98 | 0.01 | 0.01 | 0.202 | 552 | 6.248 | 1.44 | 105.0% |
| 1 | 0 | 0 | 0.201 | 550 | 6.252 | 1.44 | 100.0% |

As seen from performance in Tables 3 and 4, compositions of the present invention show improved energy efficiency (COP) versus pure E1336mzz.

1. A fluorobutene composition comprising E-1,1,1,4,4,4-hexafluoro-2-butene and a fluorinated compound selected from the group consisting of 1,1,1,2,4,4,4-heptafluorobutane, 1,1,1,3,3-pentafluoropropane, 2-chloro-1,1,1-trifluoroethane, E-1-chloro-3,3,3-trifluoropropene, Z-1-chloro-3,3,3-trifluoropropene, and 2-chloro-3,3,3-trifluoropropene, wherein the composition comprises at least 99% by weight E-1,1,1,4,4,4-hexafluoro-2-butene, wherein the fluorinated compound is present in an amount of 0.0001 to 0.9 wt %.

2. (canceled)

3. The composition of claim 1, wherein the fluorinated compound is present in an amount of 0.0005 to 0.4 wt %.

4. The composition of claim 1, wherein the fluorinated compound is present in an amount of 0.005 to 0.2 wt %.

5. The composition of claim 1, further comprising a compound selected from the group consisting of vinyl chloride, 3,3,3-trifluoro-2-(trifluoromethyl)prop-1-ene, 1,1,1,2,4,4,4-heptafluoro-2-butene, and 1,1,1,4,4,4-hexafluorobutane.

6. The composition of claim 1, further comprising Z-1,1,1,4,4,4-hexafluoro-2-butene.

7. The composition of claim 6, wherein the fluorinated compound comprises 1,1,1,2,4,4,4-heptafluorobutane.

8. The composition of claim 6, wherein the fluorinated compound comprises 2-chloro-1,1,1-trifluoroethane.

9. The composition of claim 6, comprising E-1-chloro-3,3,3-trifluoropropene, Z-1-chloro-3,3,3-trifluoropropene, 2-chloro-3,3,3-trifluoropropene, or mixtures of two or more thereof.

10. The composition of claim 1, wherein the composition comprises less than 0.1% by weight of 3,3,3-trifluoro-2-(trifluoromethyl)prop-1-ene.

11. The composition of claim 1, wherein the composition comprises less than 0.01% by weight of vinyl chloride.

12. The composition of claim 1, wherein the composition comprises less than 0.1% by weight of 3,3,3-trifluoro-2-(trifluoromethyl)prop-1-ene and less than 0.01% by weight of vinyl chloride.

13. The fluorobutene composition of claim 1,
wherein the composition comprises
Z-1,1,1,4,4,4-hexafluoro-2-butene, and the fluorinated compound comprises
1,1,1,2,4,4,4-heptafluorobutane, 2-chloro-1,1,1-trifluoroethane, E-1-chloro-3,3,3-trifluoropropene, Z-1-chloro-3,3,3-trifluoropropene, and 2-chloro-3,3,3-trifluoropropene, wherein the composition comprises greater than 99% by weight E-1,1,1,4,4,4-hexafluoro-2-butene.

14. (canceled)

15. The fluorobutene composition of claim 1, wherein
the fluorinated compound comprises:
1,1,1,3,3-pentafluoropropane and 2-chloro-1,1,1-trifluoroethane, or
1,1,1,3,3-pentafluoropropane and E-1-chloro-3,3,3-trifluoropropene, or
1,1,1,3,3-pentafluoropropane and Z-1-chloro-3,3,3-trifluoropropene, or
1,1,1,3,3-pentafluoropropane and 2-chloro-3,3,3-trifluoropropene, or
1,1,1,3,3-pentafluoropropane and 3,3,3-trifluoro-2-(trifluoromethyl)prop-1-ene,
or
1,1,1,3,3-pentafluoropropane and 1,1,1,2,4,4,4-heptafluoro-2-butene, or
2-chloro-1,1,1-trifluoroethane and E-1-chloro-3,3,3-trifluoropropene, or
2-chloro-1,1,1-trifluoroethane and Z-1-chloro-3,3,3-trifluoropropene, or
2-chloro-1,1,1-trifluoroethane and 2-chloro-3,3,3-trifluoropropene, or
2-chloro-1,1,1-trifluoroethane and 3,3,3-trifluoro-2-(trifluoromethyl)prop-1-ene,
or
2-chloro-1,1,1-trifluoroethane and 1,1,1,2,4,4,4-heptafluoro-2-butene.

16. (canceled)

17. The fluorobutene composition of claim 1, wherein the fluorinated compound comprises:
1,1,1,3,3-pentafluoropropane, 2-chloro-1,1,1-trifluoroethane, and Z-1-chloro-3,3,3-trifluoropropene, or
1,1,1,3,3-pentafluoropropane, 2-chloro-1,1,1-trifluoroethane, and E-1-chloro-3,3,3-trifluoropropene, or
1,1,1,3,3-pentafluoropropane, 2-chloro-1,1,1-trifluoroethane, and 2-chloro-3,3,3-trifluoropropene, or
1,1,1,3,3-pentafluoropropane, 2-chloro-1,1,1-trifluoroethane, and 3,3,3-trifluoro-2-(trifluoromethyl)prop-1-ene, or
1,1,1,3,3-pentafluoropropane, 2-chloro-1,1,1-trifluoroethane, and 1,1,1,2,4,4,4-heptafluoro-2-butene, or
1,1,1,3,3-pentafluoropropane, E-1-chloro-3,3,3-trifluoropropene, and Z-1-chloro-3,3,3-trifluoropropene, or
1,1,1,3,3-pentafluoropropane, E-1-chloro-3,3,3-trifluoropropene, and 2-chloro-3,3,3-trifluoropropene, or
1,1,1,3,3-pentafluoropropane, E-1-chloro-3,3,3-trifluoropropene, and 3,3,3-trifluoro-2-(trifluoromethyl)prop-1-ene, or
1,1,1,3,3-pentafluoropropane, E-1-chloro-3,3,3-trifluoropropene, and 1,1,1,2,4,4,4-heptafluoro-2-butene, or
1,1,1,3,3-pentafluoropropane, Z-1-chloro-3,3,3-trifluoropropene, and 2-chloro-3,3,3-trifluoropropene, or
1,1,1,3,3-pentafluoropropane, Z-1-chloro-3,3,3-trifluoropropene, and 3,3,3-trifluoro-2-(trifluoromethyl)prop-1-ene, or
1,1,1,3,3-pentafluoropropane, Z-1-chloro-3,3,3-trifluoropropene, and 1,1,1,2,4,4,4-heptafluoro-2-butene, or
2-chloro-1,1,1-trifluoroethane, E-1-chloro-3,3,3-trifluoropropene, and Z-1-chloro-3,3,3-trifluoropropene, or
2-chloro-1,1,1-trifluoroethane, E-1-chloro-3,3,3-trifluoropropene, and 2-chloro-3,3,3-trifluoropropene, or
2-chloro-1,1,1-trifluoroethane, E-1-chloro-3,3,3-trifluoropropene, and 3,3,3-trifluoro-2-(trifluoromethyl)prop-1-ene, or
2-chloro-1,1,1-trifluoroethane, E-1-chloro-3,3,3-trifluoropropene, and 1,1,1,2,4,4,4-heptafluoro-2-butene, or
2-chloro-1,1,1-trifluoroethane, Z-1-chloro-3,3,3-trifluoropropene, and 2-chloro-3,3,3-trifluoropropene, or
2-chloro-1,1,1-trifluoroethane, Z-1-chloro-3,3,3-trifluoropropene, and 3,3,3-trifluoro-2-(trifluoromethyl)prop-1-ene, or
2-chloro-1,1,1-trifluoroethane, Z-1-chloro-3,3,3-trifluoropropene, and 1,1,1,2,4,4,4-heptafluoro-2-butene, or
2-chloro-1,1,1-trifluoroethane, 2-chloro-3,3,3-trifluoropropene, and 3,3,3-trifluoro-2-(trifluoromethyl)prop-1-ene, or
2-chloro-1,1,1-trifluoroethane, 2-chloro-3,3,3-trifluoropropene, and 1,1,1,2,4,4,4-heptafluoro-2-butene, or
2-chloro-1,1,1-trifluoroethane, 3,3,3-trifluoro-2-(trifluoromethyl)prop-1-ene, and 1,1,1,2,4,4,4-heptafluoro-2-butene, or
E-1-chloro-3,3,3-trifluoropropene, Z-1-chloro-3,3,3-trifluoropropene, and 2-chloro-3,3,3-trifluoropropene, or
E-1-chloro-3,3,3-trifluoropropene, Z-1-chloro-3,3,3-trifluoropropene, and 3,3,3-trifluoro-2-(trifluoromethyl)prop-1-ene, or
E-1-chloro-3,3,3-trifluoropropene, Z-1-chloro-3,3,3-trifluoropropene, and 1,1,1,2,4,4,4-heptafluoro-2-butene, or
E-1-chloro-3,3,3-trifluoropropene, 2-chloro-3,3,3-trifluoropropene, and 3,3,3-trifluoro-2-(trifluoromethyl)prop-1-ene, or
Z-1-chloro-3,3,3-trifluoropropene, 2-chloro-3,3,3-trifluoropropene, and 3,3,3-trifluoro-2-(trifluoromethyl)prop-1-ene, or
Z-1-chloro-3,3,3-trifluoropropene, 3,3,3-trifluoro-2-(trifluoromethyl)prop-1-ene, and 1,1,1,2,4,4,4-heptafluoro-2-butene.

18. The fluorobutene composition of claim 1, further comprising a lubricant selected from the group consisting of mineral oils, such as paraffins, naphthenes and aromatics, alkylaryls, such as linear and branched alkyl alkylbenzenes, synthetic paraffins, synthetic naphthenes, poly(alphaolefins), polyol esters, polyalkylene glycols, and polyvinyl ethers.

19. A method of forming a foam comprising: (a) adding to a foamable composition a composition of claim 1, and (b) processing the foamable composition under conditions effective to form a foam,
wherein the foam is a thermoplastic foam, a polyurethane foam or a polyisocyanurate foam.

20-21. (canceled)

22. A process for producing aerosol products comprising the step of adding a composition of claim 1, to a formulation, including active ingredients in an aerosol container, wherein said composition functions as a propellant.

23. A process for treating a surface, comprising: providing a surface; and contacting the surface with a treatment composition;
wherein the surface includes a treatable material deposited thereon; and
wherein the treatment composition comprises the fluorobutene composition of claim 1.

24-25. (canceled)

26. A method for producing cooling comprising evaporating a composition of claim 1 in the vicinity of a body to be cooled, and thereafter condensing said composition.

27. A method for producing heat comprising condensing a composition of claim 1 in the vicinity of a body to be heated, and thereafter evaporating said compositions.

28. (canceled)

29. A process for converting heat to mechanical energy comprising heating a working fluid comprising the composition of claim 1 and thereafter expanding the heated working fluid.

30-34. (canceled)
